(19) United States
(12) Patent Application Publication
(10) Pub. No.: US 2013/0319922 A1
(43) Pub. Date: Dec. 5, 2013

(54) COMPACT AND MOBILE EQUIPMENT AND FILTERING SYSTEM FOR POTABILIZATION OF POLLUTED WATER

(71) Applicant: Ricardo Augusto FITTIPALDI DIAS, Sao Paulo (BR)

(72) Inventor: Ricardo Augusto FITTIPALDI DIAS, Sao Paulo (BR)

(21) Appl. No.: 13/900,030

(22) Filed: May 22, 2013

(30) Foreign Application Priority Data
May 29, 2012 (BR) PI 10 20120128276

(51) Int. Cl. C02F 9/00

(52) U.S. Cl. CPC C02F 9/005
USPC 210/170.09

(57) ABSTRACT

Compact and mobile equipment and filtering system for potabilization of polluted water having a device and system for treating, disinfecting and potabilizing polluted water, employed as a water treatment station; the potable water stored in a service tank, maintaining the water for immediate use or for backwashing.

### FIELD OF THE INVENTION

The current invention refers to the field of equipment which treats, disinfects and potabilizes any kind of polluted water. More specifically, the current invention refers to equipment and the respective filtering system, which is modular and mobile and can be used as a compact water treatment station, and may be transported by a cargo vehicle and/or lifted in order to allow its installation in the most diversified locations, including and mainly, those of difficult access, assuring the expansion of potable water supply to distant areas, areas with supply problems, such as from floods, landslides and other locations needing potable water. The equipment may be used by the civil defense, armed forces, city halls, enterprises and several events.

### BACKGROUND OF THE INVENTION

As it is widely known, on planet Earth there is enough pure water to supply all its inhabitants. However, due to geographical and climate factors, this supply is not possible.

There is not, however, in nature, something which could be called “pure water”; the presence of dissolved gases, organic and inorganic compounds and particles in suspension is inevitable. Water is also the natural habitat of microorganisms, microbes and aquatic plants. Also corrosive and incrusting substances are present in water, such as calcium and magnesium salts and iron and manganese compounds.

The natural waters may be classified as meteoric, superficial or groundwater and the impurities present in them vary due to the nature of the soil, climate conditions, origin and level of pollution. What is characterized, generically, as “water pollution” of rivers, reservoirs, lakes and others is due to the launching of organic wastes above the capacity of absorption by the decomposing organisms and of the non-biodegradable inorganic wastes including many toxic and cumulative ones. The sources of water pollution are various and are very disperse throughout the land surface. Although the phenomenon is more concentrated and more visible in the complex urban systems, it also arises in the natural and agricultural ecosystems and may occur many times due to climate catastrophes, such as floods, landslides in large areas and regions and even in drought regions whose reservoirs or dams present a high content of contaminants.

According to information obtained from the “ODM—FIESP/SESI/SENAI Website”, according to the 3^{rd} Report of the United Nations about Worldwide Development of the Hydro Resources, disclosed in the 5^{th} Worldwide Water Forum, (Istanbul/Turkey), performed in 2009, it was revealed that the access to the services such as potable water and basic sanitation continues inadequate in the major part of the developing countries.

Maintaining the current scenario, about five billion people—or 67% of the world population—in 2030 is going to continue without sewage disposal.

This way, the perspective of reaching the Objectives of Development of the Millennium (ODM) with 90% of the population having access to good sources of potable water in 2015 is alarming.

According to the report, the link between poverty and hydro resources is obvious, because the number of people who live with less than US$1.25 per day coincides, almost totally, with the number of those who live without potable water.

The main impact of this situation is observed in health. Almost 80% of the diseases in developing countries are associated to the water quality and cause around three million deaths per day.

It is also correct to state that the greater part of the countries has been seeking alternatives to supply potable water to the population, alternatives which usually include installation of water treatment stations, generally fixed installations, where the importance of knowing the organoleptic, physical-chemical and microbiological parameters of the water where the installation is going to be done is highlighted, in order to know how to interpret its problems and characteristics, aiming its correct use, this is, the water potabilization.

Thus, and the water available for use being of very variable composition, the treatment is imposed to it to avoid the most common problems, which are: (a) Improper water for consumption: Due to microbiological and/or organic problems or due to the existence of materials in suspension and/or dissolved; and (b) Problems in the piping and equipment: Due to corrosion of formation of incrustations.

The types of microorganisms existent in water are of many variable species, and therefore, more or less harmful to the human organism. Their origin is also varied (decomposing organic matter, contamination by urban sewage, etc.) and, in general, whenever there are conditions for them to reproduce, (light, air, organic matter, etc.) they are present. Thus, any water bacteriologically considered proper for consumption may, from one moment to the other, in case it is not conveniently disinfected, be considered improper. A simple way for the consumer to observe the good or bad quality is to verify if it is turbid or not.

We still have the problems originated by corrosion and formation of deposits in the piping and equipment in general. These occur due to the decrease of their lifetime, increase on the maintenance costs, decrease of the potable water quality, reduction of the heat exchange in the equipment, disturbances in the water circulation and the perforation of piping.

This way, whenever the water does not have good quality or does not accomplish the recommendations prescribed in the law (see Law no. 58/05), it will have to be treated through the employment of a variety of different methods or better indicated means for each situation/necessity, according to the characteristics of the water to be treated.

The disinfection is one of the most important stages in the treatment of potable water, because it enables the elimination of all the kinds of germs, susceptible of provoking and transmitting the most variable diseases.

The disinfection is normally performed by the dosing of sodium hypochlorite. While an insufficient dosing may not assure the disinfection of the water, the excessive dosing is responsible for unpleasant odors and flavors in potable water, which cannot be considered of good quality.

The correction of the pH is also another stage employed in the water treatment. A bad measure of pH may be responsible for inferior quality water, due to deficient results on the clearing process or by aggravation of the aggressive or incrusting trend of the water. For these reasons this stage is very important for good quality of final water.

The clearing stage to obtain potable water consists on the removal of matter in suspension (turbidity), it may be performed by two processes (together or not): (i) Decantation: It is performed by the addition of chemical products, which are called coagulants or flocculants, and present the property of attracting the particles in suspension, forming bigger flakes which are easily deposited by decantation. In this phase the pH adjustment is extremely important, as these chemical products present a well delimited pH range in which they act; and (ii) Filtration: It must be performed after the decantation in a way that the greater part of the materials in suspension have already been removed by decanting, or in alternative, in case the matter in suspension is scarce.

The adsorption stage of the substances which give taste/flavor to the water to become potable is of greater or lesser importance, according to the content of matter present in it being higher or lower. In fact, the organic matter is responsible for strong odors and flavors which cannot be totally eliminated by dosing sodium hypochlorite. In these cases, after chlorinating the water, it goes through an activated carbon filter, a substance capable of absorbing and removing all the organic matter existent in water, as well as the excess of hypochlorite.

Other water treatments which can be used are: (a) Decalcification: these are equipment similar to filters which have exchange resins inside which retain the high content of calcium and of magnesium; (b) Denitrification: The denitrifiers are equipment similar to the decalcifiers, but they have exchange resins inside which retain the high content of nitrates in the water; and (c) Deferrization: Iron, in high quantities, may be removed by passing water in a filter which has a chemical product inside (type of ionic resin), which has the capability of absorbing iron.

### Description of the Current State of the Technique

Facing the exposed to obtain potable water in condition for human consumption it is necessary to implant water treatment stations—WTS—, very well known in the urban centers and which practically constitutes the occupation of a large physical area where a set of physical and chemical procedures applied to the water are performed so that it gets into adequate conditions for consumption, this is, for it to become potable.

In a water treatment station—WTS—, the process occurs in the following stages:

Coagulation: when the water in its natural form (raw) enters the WTS it receives a certain quantity of aluminum sulfate in the tanks. This substance is to agglomerate (join) solid particles which are found in the water, for example, clay.
Flocculation: in concrete tanks with the water moving, the solid particles agglomerate in bigger flakes.
Decantation: in other tanks, by means of gravity, the flakes with the impurities and particles are deposited on the bottom of the tanks, separating from the water.
Filtration: the water passes through filters formed by carbon, sand and stones of several sizes. In this stage the small size impurities are retained in the filter.
Disinfection: chlorine or ozone is applied to the water to eliminate microorganisms that cause diseases.
Fluoridation—fluoride is applied to the water to prevent the formation of dental caries in children.
pH Correction—a certain quantity of hydrated lime or sodium carbonate is applied to the water. This procedure is to correct the water pH and preserve the piping distribution network.

This type of treatment station is used in the world and requires large areas for its installation as well as it represents high investments. An example of water treatment station may be seen in document PI 0103928-8 (2001), or those used by sanitation companies in some of the great population cities in Brazil and other locations.

Some other models of water treatment station can be assembled in a smaller dimension and, consequently, work with compatible volumes of water, as we can observe in the patent documents found in a brief research performed in specific databanks, one of them being the no. PI 0106452-5 (2003), which is a WTS designed to operate through a quick mixture chamber, flocculator in porous means, flotation chamber by dissolved air and sand filter of descending flow, being complemented by pressurizing chamber, dosing equipment and recirculation and washing pumps. The objective is to use the flotation by dissolved air allied to the intensified coagulation configuring into an algae and organic dissolved matter removing process.

However, the observations of the current state of the technique reveal the necessity of a practical, mobile station and of easy installation, which can be conducted to the most diverse sites which need potable water.

### BRIEF DESCRIPTION OF THE INVENTION

Thus, in order to meet the current necessities, the applicant has developed the present patent of invention, where a system and its respective modular equipment is presented, which is employed for immediate water treatment, this is, its installation in the site is enough to have potable water in abundance in a few minutes.

The equipment comprehends a compact and mobile unit, which is capable of potabilization of polluted water in any site, even of difficult access, such as in catastrophes and other local problems. The equipment includes a series of filtering devices, mainly two identical filters which operate in parallel, each one conformed by filtering membranes disposed in series which execute the water filtering and purification in a mechanical way, this is, on an “a” stage removes the big particles (sand, rust and others), on the “b” stage eliminates the chemical substances (chlorine, pesticides and others), improving the water flavor and odor and on the “c” stage the last membrane formed by a 0.14 micron thickness screen makes the water totally free from bacteria, virus, algae and others.

The filtering system formed by multiple filters of carbon, UV and, particularly the membrane filters is capable of, in a sequence of water entry and exit, treating the polluted water by means of an arrangement applied in the mentioned unit, transforming polluted water into potable in a few minutes.

The equipment may be installed in the most diversified locations, as it can be transported by land vehicles, or it may be lifted by helicopters and cranes, solving potable water supply problems such as in floods, landslides and other local ones. The equipment may be used by the civil defense, armed forces, city halls, enterprises and several events.

### BRIEF DESCRIPTION OF THE FIGURES

To complement the present description in order to obtain a better comprehension of the characteristics of the invention and according to a preferential practical performance, the description is accompanied in attachment by a set of drawings, where, in an exemplified way, although not limiting, the following was represented:

FIG. 1 shows in perspective the unit which comprises the equipment and the respective water treatment system;

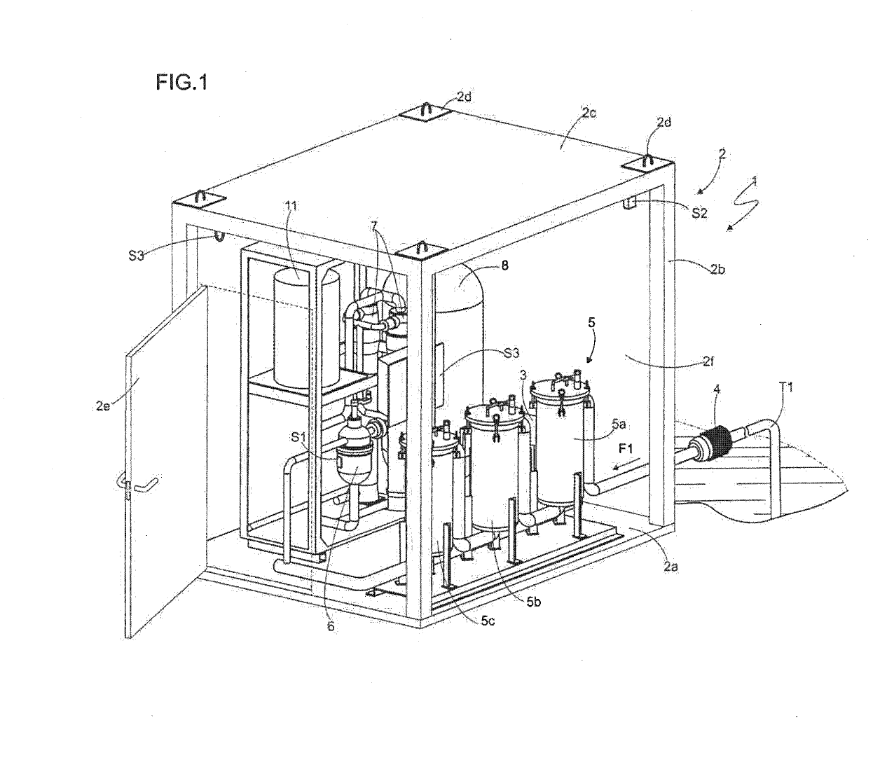

FIG. 2 shows another perspective, now without its protection walls, allowing to enlarge the arrangement of the devices which comprise the equipment to better visualize them;

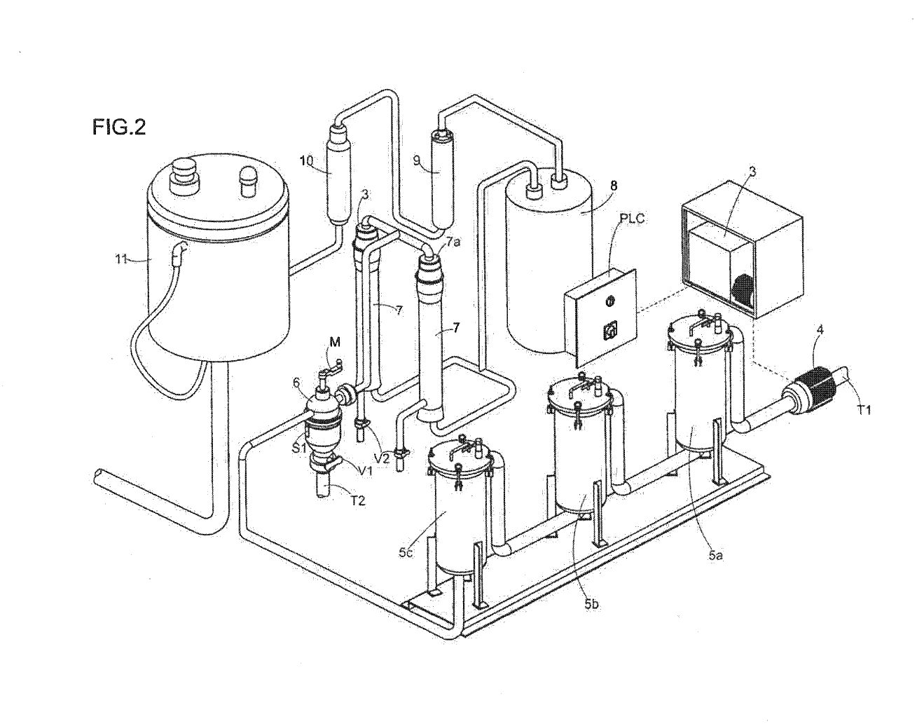

FIG. 3 represents a block diagram of the water filtering and purification system performed in the equipment in the issue.

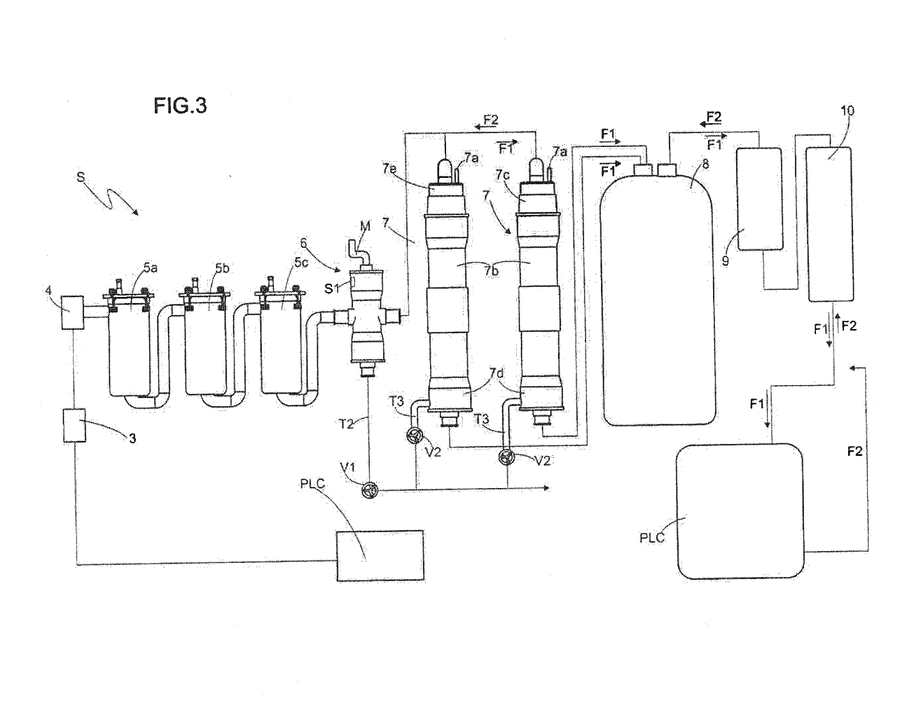

### DETAILED DESCRIPTION OF THE INVENTION

Although the present invention may be susceptible to different modalities, a preferred modality is shown in the drawings and in the following detailed discussion with the understanding that the present description must be considered an exemplification of the principles of the invention and does not intend to be limited to what is illustrated and described here.

The system and equipment (1) of the current invention, belongs to the field of the equipment which treat, disinfect and potabilize any kind of polluted water.

According to the invention, the innovated equipment (1) comprises a thermo-acoustic module (2), formed by a metal structure composed by lower base or floor (2a), columns (2b) and upper base (2c), provided with lifting lugs (2d), a module which includes at least one door (2e) and whose walls may be configured by metal plates (2f), acrylic or other adequate material. Inside the module (2) multiple water filters are arranged in series and communicating among themselves by means of piping in closed circuit, making up a single course (F1) to treat the polluted water which enters the equipment (1) and, eventually, when necessary, a water return course (F2) for backwashing the filters.

For the potabilization operation of the polluted water the equipment includes a power generator (3), preferably of 10 Kva and powered by biodiesel, which can generate electricity to power the water pump (4), whose polluted water capturing hose (T1) must be maintained immersed in the polluted water (AP) of the river, lake or other location, and a panel (PLC) which controls the automation of the filtering system.

The water filtering and purification system (S) is performed mechanically by a set of filters composed in the following way:
(i) Set of primary filters (5);
(ii) Pre-filter (6) or supply filter, equipped with clogging alert sensor (S1) and crank (M) to help on the manual cleaning;
(iii) Set of membrane filters (7);
(iv) Activated carbon filter and iolites (8);
(v) Chlorine addition system (9);
(vi) UV bulb (10).

At the end of the filtering, according to course (F1), the potable water is stored in a service tank (11) which maintains the water for use or for backwashing, when necessary.

The equipment (1) is modular and can preferably adopt a dimension of 2 m×2 m (base)×2.5 m (height). The weight to allow its lifting is between 900 and 1200 kg. The service pressure is of 2.5 bar and the equipment can operate in temperature varying from 0 to 40° C. The flow rate is of 2 m³/hour.

The set of primary filters (5) is formed by at least three filters known as “bag”, with retaining ranges and contaminant removal characteristics, particularly solid particles, different from one another. The filter (5a) coupled to the water pump (4) has a 300 microns bag, while the subsequent filters which are filter (5b) is of 100 microns and filter (5c) is of 50 microns.

The pre-filter (6) is also of the “bag” type and presents filtering capacity of particles smaller than 5 microns. It has a sensor (S1) coupled, which is responsible for alerting the control panel (PLC) of clogging, making the backwashing of the equipment (1) occur automatically or manually, by means of the crank (M) and valve (V1), whose backwashing water flows through piping (T2) out of the equipment.

The filtering water, according to course (F1), after passing through the pre-filter (6) of 5 microns follows to the set of membrane filters (7), each one comprised of a cylinder (7b), provided with an upper cap (7c) and lower cap (7d) and a membrane obstruction indicator (7a). The functioning of each membrane filter (7) is performed in three filtering stages, which are:

stage “a”—pre-filtering—removes the big particles (sand, rust and others);
stage “b”—filtration—eliminates the chemical substances (chlorine, pesticides and others), improving the water flavor and odor;
stage “c”—purification—membrane formed by a 0.14 micron thickness screen makes the water totally free from bacteria, virus, algae and others.

The water purified in the membrane filters (7) follows to the activated carbon filter (8), chlorine addition filter (9) and is submitted to UV rays in filter (10) to deal with the pathogens harmful to water, finally stored in the service tank (11) with capacity for at least 320 liters of potable water.

The panel (PLC) is responsible for the automation of the system in the equipment and, for this, includes the functions of: (a) energizing the module (2) and all the devices, such as on/off button, timers, sensor (S1), smoke sensor (S2) and emergency sensors (S3) which operate together with sensors (S2) and are applied for safety of the equipment.

Although the equipment operates automatically, human intervention may be necessary. For this purpose, two mechanical indicators are foreseen:—pre-filter indicator (6) or supply filter, formed by sensor (S1) and—indicator (7a) of membrane obstruction of the membrane filters (7).

These indicators must be verified at least every 4 hours, and when cleaning is necessary, the necessary time for cleaning and backwashing is approximately 15 minutes.

For cleaning the pre-filter (6) the following stages are necessary:

the equipment must be maintained with its functioning in the flow direction (F1) and the operator opens the valve (V1), allowing the outflow of the water;
the crank (M) must be unlocked (turned up) and spun in the clockwise direction to evacuate the dirt from inside the filter. At least 10 complete spins with the crank (M) are recommended;
the crank (M) must return to the original position and the valve (V1) must be closed;
the crank (M) is pushed down and then locked.

The cleaning of the membrane filters (7) is performed chemically and must be done every time the indicator (7a), installed on top of the cylinder (7b), indicates the need. To start the cleaning of the membrane filters (7), the service tank (11) must be full and the equipment must be off. These stages follow:

preparation, separately and in an adequate flask, of chemical solution formed by hypochlorite of granulated calcium and water, agitate until the chlorine hypochlorite is dissolved;
add this chemical solution to the service tank (11);
on the panel (PLC) the operator must activate the “chemical cleaning” button which will occur during a pre-determined period of time;
the valves (V2) arranged in the piping (T3) below each membrane filter (7) are opened so that the cleaning water is discarded in piping (T2) and sent out of the equipment (1);
in the panel (PLC) the button—on—is activated and the water flow occurs in the (F2) direction during a pre-determined period of time until it disconnects automatically;
at the end of the cleaning period valves (V2) must be closed and the indicators (7a) must be pushed manually to their original position for a new reading of each filter (7); and
the panel (PLC) must have the button—on—activated and the equipment (1) will begin a new filtering.

The equipment (1) is independent of the electric energy supply, as it has its own generator (3). It must be positioned in a firm and horizontal surface, this is, not wavy or unstable and, preferably close to the margin of the polluted water site (AP). The water from the filter cleanings and chemical cleanings of the equipment are discarded by piping (T3) that must be positioned in the river flow with polluted water (AP) after the capturing hose (T1) which feeds the water pump (4).

It is right that when the current invention is put into practice, modifications may be introduced concerning certain construction and form details, without this implying in departing from the fundamental principles which are clearly substantiated in the claiming frame, thus understanding that the terminology employed had the purpose of not limiting.

1. A compact and mobile equipment and filtering system for potabilization of polluted water having an equipment (1) having a device and system for treating, disinfecting and potabilizing polluted water, employed as a water treatment station; characterized by the fact that the equipment (1) is comprised by a thermo-acoustic module (2), formed by a metal structure composed by lower base or floor (2a), columns (2b) and upper base (2c), provided with lifting lugs (2d), a module which includes at least one door (2e) and whose walls may be configured by metal plates (2f), acrylic or other adequate material. Inside the module (2) multiple water filters are arranged in series and communicating among themselves by means of piping in closed circuit composing a filtering and purification system (S) of polluted water (AP) which makes up a single course (F1) to treat the polluted water (AP) which enters the equipment (1) and, when necessary, makes a single water return course (F2) for returning the treated water for backwashing the filters, the equipment including a power generator (3) which can generate electricity to power the water pump (4), whose polluted water capturing hose (T1) must be maintained immersed in the polluted water (AP) of river, lake or other location, and a panel (PLC) which controls the automation of the water filtering and purification system (S) which is performed mechanically by a set of filters composed in the following way:
(i) set of primary filters (5);
(ii) pre-filter (6) or supply filter, equipped with clogging alert sensor (S1) and crank (M) to help on the manual cleaning;
(iii) set of membrane filters (7);
(iv) activated carbon filter and iolites (8);
(v) chlorine addition system (9);
(vi) UV bulb (10),
wherein, at the end of the filtering, according to course (F1), the potable water is stored in a service tank (11) which maintains the water for use or for backwashing.

2. The filtering equipment according to claim 1, characterized by the equipment (1) being modular and preferably adopting dimensions 2 m×2 m (base)×2.5 m (height).

3. The filtering equipment according to claim 1, characterized by the equipment (1) being mobile by transportation or lifting; the total weight of the module ranging from 900 to 1200 kg.

4. The filtering equipment according to claim 2, characterized by equipment (1) being mobile by transportation or lifting; the total weight of the module ranging from 900 to 1200 kg.

5. The filtering equipment according to claim 1, characterized by the set of primary filters (5) is formed by at least three filters of the “bag” type, with retaining ranges and contaminant removal characteristics, particularly solid particles, different from one another. The filter (5a) coupled to the water pump (4) has a 300 microns bag, while the subsequent filters which are filter (5b) is of 100 microns and filter (5c) 15 is of 50 microns.

6. The filtering equipment according to claim 1, characterized by the pre-filter (6) which is also of the “bag” type and presents filtering capacity of particles smaller the 5 microns. It is foreseen with a sensor (81) coupled to the pre-filter, which is capable of alerting the control panel (PLC) concerning clogging of this filter. The 20 cleaning of the pre-filter (6) is done automatically or manually by means of the crank (M) and valve (V1) and occurs during the backwashing of the equipment (1); the cleaning water of the pre-filter (6) flows through piping (T2) out of the equipment.

7. The filtering equipment according to claim 1, characterized by the set of membrane filters (7) includes at least two filters, each one comprised of a cylinder 25 (7b), provided with an upper cap (7c) and lower cap (7d) and a membrane obstruction indicator (7a); the functioning of each membrane filter (7) is performed in three filtering stages, which are:
stage “a” -pre-filtering—removes the big particles (sand, rust and others);
stage “b”—filtration—eliminates the chemical substances (chlorine, pesticides and others), improving the water flavor and odor;
stage “c”—purification—membrane formed by a 0.14 micron thickness screen makes the water totally free from bacteria, virus, algae and others.

8. The filtering equipment according to claim 1, characterized by the service tank (11) presenting capacity of at least 320 liters of potable water.

9. The filtering equipment according to claim 1 and in a preferential option, characterized by the energy generator (3) being of 10 Kva and powered by biodiesel.

10. The filtering equipment according to claim 1, characterized by the panel (PLC) automating the filtering and backwashing system performed by equipment (1) and includes the functions of: (a) energizing the module (2) and all the devices, such as on/off button, timers, sensor (S1), smoke sensor (S2) and emergency sensors (S3) which operate together with sensors (S2).
